(19) United States
(12) Patent Application Publication
(10) Pub. No.: US 2025/0015972 A1
(43) Pub. Date: Jan. 9, 2025

(54) COMMUNICATION SYSTEM, TRANSMISSION APPARATUS, RECEPTION APPARATUS, AND METHOD AND PROGRAM THEREOF

(71) Applicant: NEC Corporation, Minato-ku, Tokyo (JP)

(72) Inventor: Kazuhiko Minematsu, Tokyo (JP)

(73) Assignee: NEC Corporation, Minato-ku, Tokyo (JP)

(21) Appl. No.: 18/709,089

(22) PCT Filed: Nov. 19, 2021
(86) PCT No.: PCT/JP2021/042623

§ 371 Date: May 10, 2024

(51) Int. Cl. H04L 9/06; H04L 1/00

(52) U.S. Cl. CPC H04L 9/0643; H04L 1/0042; H04L 1/0061

(57) ABSTRACT

A transmission apparatus includes: a first ECC part that calculates a first error correction code from the message; an ENC part that additively encrypts a concatenation of the message and the first error correction code using a random number obtained by supplying the nonce to the pseudorandom function to output a ciphertext; a MAC part that calculates a message authentication tag for the message and the nonce using the common key; a second ECC part that calculates a second error correction code from the nonce; and a transmission part that transmits the ciphertext, the message authentication tag, the nonce, and the second error correction code to the reception apparatus.

### TECHNICAL FIELD

The present invention relates to a communication system, transmission apparatus, reception apparatus, and method and program thereof.

### BACKGROUND ART

Message Authentication Code (MAC) is a technology that guarantees that a message is valid by adding a tag that only one who knows a common key can calculate to the message. For instance, by using message authentication, one is able to detect tampering by a third party performed during communication between two parties sharing a common key. Concretely, when K is a common key shared by the sender and receiver of a message and M is the message, the sender sends a tag T=MAC (K, M) to the receiver along with the message M. Note that MAC (K, M) indicates a function F that receives M and K, and outputs the tag T.

The message and tag received by the receiver via a communication channel are denoted as message M′ and tag T′, respectively. The receiver who has received the message M′ and the tag T′ calculates a tag T″ using the received message M′ and the key K shared with the sender. Here, the receiver is able to determine whether or not the message M′ is sent from a valid sender by confirming whether or not the received tag T′ matches the tag T″.

Meanwhile, since errors may occur due to natural factors in communication, an error correction code (ECC) is usually applied. At this time, the error correction code is normally applied to the entire content of the communication. Therefore, when message authentication is used, an error correction code encoding process is performed on the entire sequence (M∥T) in which the message M and the tag T=MAC (M) are concatenated (“∥” indicates a concatenation operator). When encoding processing on an arbitrary binary sequence x is g(x), the transmitted content is g(M∥MAC (M)). The receiver first performs error correction processing and performs MAC verification processing on the obtained estimated value of (M∥T).

Further, Patent Literature 1 describes a method for applying an error correction code to a message M rather than to the entire communication content and for performing message authentication processing and error correction code processing in parallel.

### CITATION LIST

### Patent Literature

### Patent Literature 1:

International Publication Number WO2018/109906A1

### SUMMARY

### Technical Problem

The disclosure of the literature in Citation List above is incorporated herein in its entirety by reference thereto. The following analysis is given by the present inventors.

Authenticated encryption (AE) is a communication technology that encrypts a message for communication and guarantees that the message is legitimate. This technique combines the message authentication described above with encryption.

Further, just as it is common to apply an error correction code in the message authentication described above, it is also common to apply an error correction code in authenticated encryption by applying the error correction code to the entire communication content.

Then, authenticated encryption processing and error correction code processing may be performed in parallel as in Patent Literature 1, but a combination that simply adds encryption before and after the technique described in Patent Literature 1 cannot function correctly. This is because approaches for combining encryption and message authentication in authenticated encryption include the Encrypt-then-MAC (EtM) approach in which the message is first encrypted and then a MAC tag is calculated from the resulting ciphertext, the MAC-then-Encrypt (MtE) approach in which a MAC is calculated from the message and then the concatenated message and MAC tag are encrypted together, and the Encrypt-and-MAC (EaM) approach in which a MAC tag is calculated from the message, which is encrypted, and then the ciphertext and MAC tag are concatenated and transmitted together, and the relationship between each process in authenticated encryption and error correction code processing must be appropriately combined.

In view of the problem above, it is an object of the present invention to provide a communication system, transmission apparatus, reception apparatus, and method and program thereof that contribute to the parallelization of authenticated encryption processing and error correction code processing.

### Solution to Problem

According to a first aspect of the present invention, there is provided a communication system transmitting a message from a transmission apparatus to a reception apparatus using a common key and a pseudorandom function shared by the transmission apparatus and the reception apparatus, and a nonce generated by the transmission apparatus, wherein the transmission apparatus comprises: a first ECC part that calculates a first error correction code from the message; an ENC part that additively encrypts a concatenation of the message and the first error correction code using a random number obtained by supplying the nonce to the pseudorandom function to output a ciphertext; a MAC part that calculates a message authentication tag for the message and the nonce using the common key; a second ECC part that calculates a second error correction code from the nonce; and a transmission part that transmits the ciphertext, the message authentication tag, the nonce, and the second error correction code to the reception apparatus, and the reception apparatus comprises: a second ECC decoding part that performs error correction on the nonce using the second error correction code; a DEC part that decodes the message and the first error correction code from the ciphertext using a random number obtained by supplying the nonce to the pseudorandom function; a first ECC decoding part that performs error correction on the message using the first error correction code; a verification MAC part that calculates a verification message authentication tag using the common key from the message outputted by the first ECC decoding part and the nonce outputted by the second ECC decoding part; and an output part that compares the verification message authentication tag with the message authentication tag and outputs the message if the difference therebetween is within a predetermined range.

According to a second aspect of the present invention, there are provided a transmission apparatus and a reception apparatus constituting the communication system.

According to a third aspect of the present invention, there is provided a communication method transmitting a message from a transmission apparatus to a reception apparatus using a common key and a pseudorandom function shared by the transmission apparatus and the reception apparatus, and a nonce generated by the transmission apparatus, the communication method including causing the transmission apparatus to: calculate a first error correction code from the message; additively encrypt a concatenation of the message and the first error correction code using a random number obtained by supplying the nonce to the pseudorandom function to output a ciphertext; calculate a message authentication tag for the message and the nonce using the common key; calculate a second error correction code from the nonce; and transmit the ciphertext, the message authentication tag, the nonce, and the second error correction code to the reception apparatus; and causing the reception apparatus to: perform error correction on the nonce using the second error correction code; decode the message and the first error correction code from the ciphertext using a random number obtained by supplying the nonce to the pseudorandom function; perform error correction on the message using the first error correction code; calculate a verification message authentication tag using the common key from the error-corrected message and the error-corrected nonce; and compare the verification message authentication tag with the message authentication tag and output the message if the difference therebetween is within a predetermined range.

According to a fourth aspect of the present invention, there are provided a transmission method and a reception method constituting the communication method.

According to a fifth aspect of the present invention, there is provided a communication program causing a transmission apparatus and a reception apparatus to perform a process of transmitting a message from the transmission apparatus to the reception apparatus using a common key and a pseudorandom function shared by the transmission apparatus and the reception apparatus, and a nonce generated by the transmission apparatus, wherein the communication program causes the transmission apparatus to perform processes of: calculating a first error correction code from the message; additively encrypting a concatenation of the message and the first error correction code using a random number obtained by supplying the nonce to the pseudorandom function to output a ciphertext; calculating a message authentication tag for the message and the nonce using the common key; calculating a second error correction code from the nonce; and transmitting the ciphertext, the message authentication tag, the nonce, and the second error correction code to the reception apparatus, and the communication program causes the reception apparatus to perform processes of: performing error correction on the nonce using the second error correction code; decoding the message and the first error correction code from the ciphertext using a random number obtained by supplying the nonce to the pseudorandom function; performing error correction on the message using the first error correction code; calculating a verification message authentication tag using the common key from the error-corrected message and the error-corrected nonce; and comparing the verification message authentication tag with the message authentication tag and outputting the message if the difference therebetween is within a predetermined range.

According to a sixth aspect of the present invention, there are provided a transmission program and a reception program constituting the communication program.

Further, these programs can be stored in a computer-readable storage medium. The storage medium may be a non-transitory one such as a semiconductor memory, a hard disk, a magnetic recording medium, an optical recording medium, and the like. The present invention can also be realized as a computer program product.

### Advantageous Effects of Invention

According to each aspect of the present invention, there can be provided a communication system, transmission apparatus, reception apparatus, and method and program thereof that contribute to the parallelization of authenticated encryption processing and error correction code processing.

### BRIEF DESCRIPTION OF DRAWINGS

FIG. 1 is a schematic configuration diagram of a communication system relating to a first example embodiment.

FIG. 2 is a function block diagram of a transmission apparatus relating to the first example embodiment.

FIG. 3 is a function block diagram of a reception apparatus relating to the first example embodiment.

FIG. 4 is a flowchart schematically showing the procedure of a transmission method relating to the first example embodiment.

FIG. 5 is a flowchart schematically showing the procedure of a reception method relating to the first example embodiment.

FIG. 6 is a drawing showing an example of the hardware configuration of the apparatuses used in the example embodiments.

FIG. 7 is a schematic configuration diagram of a communication system relating to a second example embodiment.

FIG. 8 is a function block diagram of a transmission apparatus relating to the second example embodiment.

FIG. 9 is a function block diagram of a reception apparatus relating to the second example embodiment.

### EXAMPLE EMBODIMENTS

Example embodiments of the present invention will be described with reference to the drawings. The present invention, however, is not limited to the example embodiments described below. Further, in each drawing, the same or corresponding elements are appropriately designated by the same reference signs. It should also be noted that the drawings are schematic, and the dimensional relationships and the ratios between the elements may differ from the actual ones. There may also be parts where the dimensional relationships and the ratios between drawings are different.

### First Example Embodiment

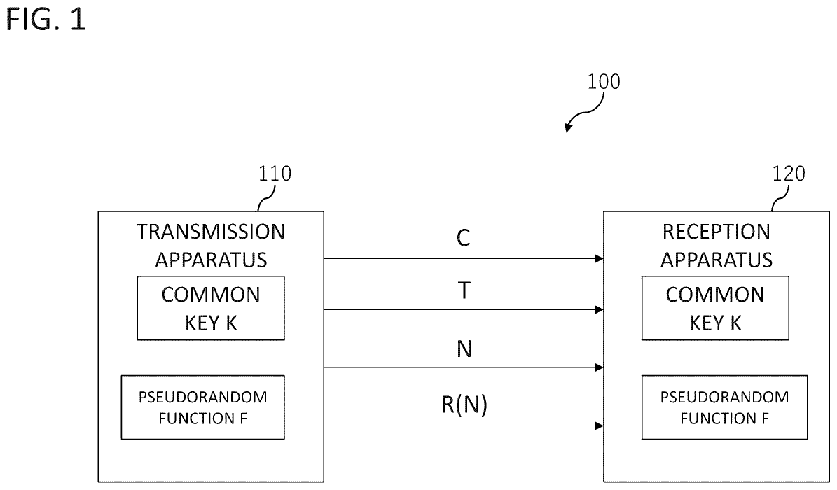

FIG. 1 is a schematic configuration diagram of a communication system relating to a first example embodiment. As shown in FIG. 1, the communication system 100 is a system for transmitting a message from a transmission apparatus 110 to a reception apparatus 120 using authenticated encryption with error correction functionality. To achieve this, the transmission apparatus 110 and the reception apparatus 120 share a common key K and a pseudorandom function F. The common key K is used for message authentication when transmitting a message using authenticated encryption, and the pseudorandom function F is used to generate a random number used for encryption. Further, sharing the pseudorandom function F is achieved not only by sharing the same function but also by sharing a seed for generating a random number. The seed for generating a random number essentially functions as a common key.

As shown in FIG. 1, the transmission apparatus 110 transmits a ciphertext C, a message authentication tag T, a nonce N, and an error correction code R(N) to the reception apparatus 120. With these pieces of information, a mechanism described later is used to transmit a message from the transmission apparatus 110 to the reception apparatus 120 using authenticated encryption with error correction functionality.

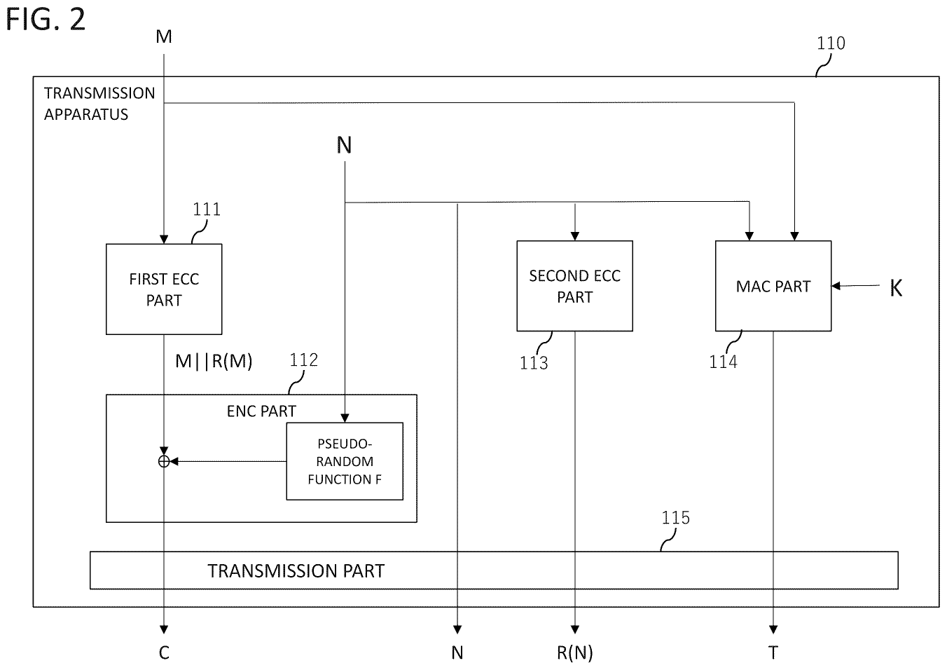

FIG. 2 is a function block diagram of the transmission apparatus relating to the first example embodiment. As shown in FIG. 2, the transmission apparatus 110 comprises a first ECC part 111, an ENC part 112, a second ECC part 113, a MAC part 114, and a transmission part 115.

The first ECC part 111 calculates a first error correction code R(M) from a message M and outputs a concatenation M∥R(M) of the message M and the first error correction code R(M). The ENC part 112 encrypts M∥R(M) outputted from the first ECC part 111 into the ciphertext C. Here, the error correction method used by the first ECC part 111 can be chosen appropriately according to the communication protocol, and it is assumed to be a linear code.

The ENC part 112 calculates the ciphertext C using M∥R(M) outputted from the first ECC part 111 and the nonce N. The nonce N is a disposable random number generated by the transmission apparatus 110, and it can be generated using a counter, for instance. The pseudorandom function F in the first ECC part 111 outputs a random number for an input of the nonce N, and this random number is added to M∥R(M) outputted from the first ECC part 111. In other words, M∥R(M) outputted from the first ECC part 111 is additively encrypted using the random number obtained by supplying the nonce N into the pseudorandom function F.

The second ECC part 113 calculates the second error correction code R(N) from the nonce N. Further, using the common key K, the MAC part 114 calculates the message authentication tag T from an input of the message M and the nonce N.

The transmission part 115 transmits the ciphertext C, the message authentication tag T, the nonce N, and the second error correction code R(N) calculated as described above to the reception apparatus 120.

As evident from the above explanation, in the transmission apparatus 110 shown in FIG. 2, the processing in the first ECC part 111 and the ENC part 112, the processing in the second ECC part 113, and the processing in the MAC part 114 are performed in parallel. Therefore, the transmission apparatus 110 minimizes the delay from the input of the message M to the transmission of the ciphertext C, etc., to the reception apparatus 120. In addition, compared to the method that applies an error correction code to the entire communication content, commonly used in a conventional communication system, the computational complexity and communication volume are reduced since error correction code processing is not performed on the message authentication tag T.

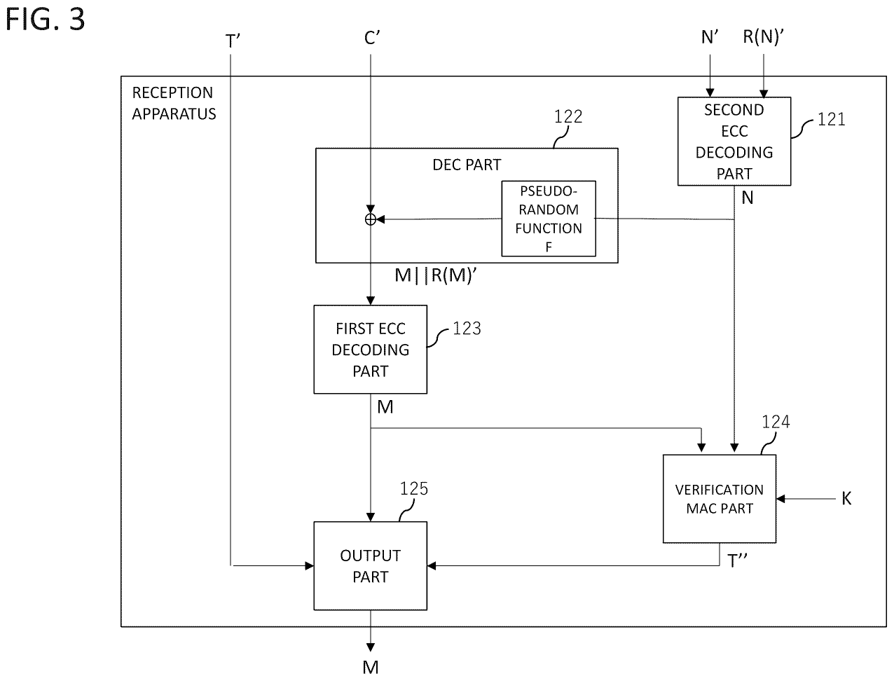

FIG. 3 is a function block diagram of the reception apparatus relating to the first example embodiment. As described above, the communication content transmitted by the transmission apparatus 110 differs from what is generally used in conventional communication methods, and as explained below, the reception apparatus 120 is capable of decoding the message M from a ciphertext C′, a message authentication tag T′, a nonce N′, and a second error correction code R(N)′ received from the transmission apparatus 110. Note that it is assumed that the ciphertext C′, the message authentication tag T′, the nonce N′, and the second error correction code R(N)′ received from the transmission apparatus 110 contain noise or have been tampered with; therefore, by adding the apostrophes, they are distinguished from the ciphertext C, the message authentication tag T, the nonce N, and the second error correction code R(N) transmitted by the transmission apparatus 110.

As shown in FIG. 3, the reception apparatus 120 comprises a second ECC decoding part 121, a DEC part 122, a first ECC decoding part 123, a verification MAC part 124, and an output part 125.

The second ECC decoding part 121 performs error correction on the nonce N′ using the second error correction code R(N)′. If the error correction is successful, the second ECC decoding part 121 outputs the nonce N transmitted by the transmission apparatus 110. On the other hand, if the error correction fails, the process terminates as it indicates a failure to correctly receive the communication content.

The DEC part 122 decodes the ciphertext C′ received from the transmission apparatus 110 using the nonce N error-corrected by the second ECC decoding part 121. The nonce N is supplied to the pseudorandom function F in the DEC part 122 to generate a random number. At this time, since the pseudorandom function F is shared by the transmission apparatus 110 and the reception apparatus 120, the same random number is generated for the same nonce N. Therefore, by calculating the difference between the random number generated by the pseudorandom function F and the ciphertext C′ received from the transmission apparatus 110, the ciphertext C′ can be decoded. The result of decoding the ciphertext C′ is a concatenation M∥R(M)′ of a message M′ and a first error correction code R(M)′.

The first ECC decoding part 123 can decode the message M by performing error correction on M∥R(M)′. The reason is explained below. Note that, if the error correction fails, the process terminates as it indicates a failure to correctly receive the communication content.

The received ciphertext C′ can be considered to be the transmitted ciphertext C with an added error vector e. In other words, C′=C+e. Meanwhile, since the DEC part 122 performs additive decoding, the result obtained is M∥R(M)+e. Here, since the first error correction code R(M) is encoded with a linear code, one can obtain the message M if the error vector e can be error-corrected.

The verification MAC part 124 uses the common key K to calculate a verification message authentication tag T″ from the message M decoded by the first ECC decoding part 123 and the nonce N decoded by the second ECC decoding part 121. If the message M (and the nonce N) has not been tampered with, this verification message authentication tag T″ should match the message authentication tag T generated by the MAC part 114 in the transmission apparatus 110.

The output part 125 compares the verification message authentication tag T″ with the message authentication tag T′ received from the transmission apparatus 110, and if the difference therebetween is within a predetermined range, the output part 125 outputs the message M obtained by the first ECC decoding part 123. Here, the message authentication tag T′ received from the transmission apparatus 110 does not necessarily match the message authentication tag T generated by the MAC part 114 in the transmission apparatus 110. In other words, the verification message authentication tag T″ may not match the message authentication tag T′ received from the transmission apparatus 110 even if the message M has not been tampered with. Therefore, if the difference between the verification message authentication tag T″ and the message authentication tag T′ received from the transmission apparatus 110 is within the predetermined range, the output part 125 determines that the message M has not been tampered with and outputs the message M obtained by the first ECC decoding part 123. The output part 125 can use the Hamming distance to compare the verification message authentication tag T″ with the message authentication tag T′ received from the transmission apparatus 110.

As described above, the communication content transmitted by the transmission apparatus 110 is different from what is generally used in the conventional authenticated encryption with error correction functionality, however, the reception apparatus 120 is capable of decoding the message M while performing error correction and message authentication.

### (Communication Method)

Now a communication method relating to the first example embodiment will be described. The communication method relating to the first example embodiment can be implemented by the communication system 100 comprising the transmission apparatus 110 and the reception apparatus 120 described above. Below, a transmission method performed by the transmission apparatus 110 and a reception method performed by the reception apparatus 120 will be explained separately.

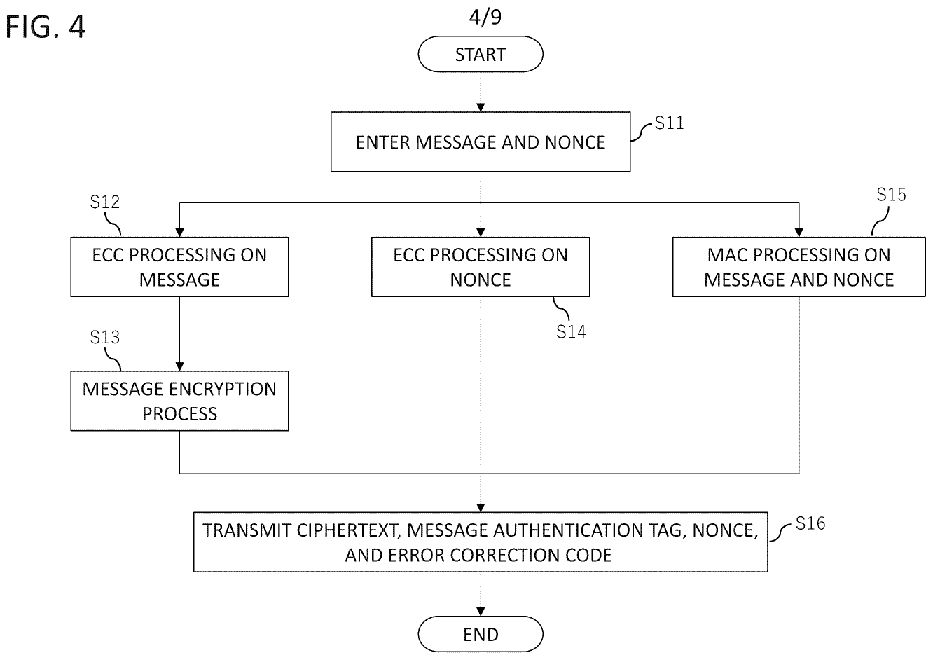

FIG. 4 is a flowchart schematically showing the procedure of the transmission method relating to the first example embodiment. The transmission method relating to the first example embodiment is a method for transmitting a message M to the reception apparatus 120 using the common key K and the pseudorandom function F shared with the reception apparatus 120, and the generated nonce N.

As shown in FIG. 4, an input of the message M and the nonce N are received in step S11. As already explained, the nonce N is a disposable random number, and for instance, it can be generated using a counter. In other words, the nonce N may be generated within the apparatus rather than being externally supplied.

Step S12 calculates the first error correction code R(M) from the message M to obtain the concatenation M∥R(M) of the message M and the first error correction code R(M). The error correction method here can also be chosen appropriately according to the communication protocol, and it is assumed to be a linear code.

Step S13 calculates the ciphertext C using the nonce N from the concatenation M∥R(M) of the message M and the first error correction code R(M) obtained in the step S12. Using a random number obtained by supplying the nonce N to the pseudorandom function F, additive encryption is performed on the concatenation M∥R(M) of the message M and the first error correction code R(M).

Meanwhile, step S14 calculates the second error correction code R(N) from the nonce N. Further, using the common key K, step S15 calculates the message authentication tag T from an input of the message M and the nonce N.

Finally, step S16 transmits the ciphertext C, the message authentication tag T, the nonce N, and the second error correction code R(N) calculated as described above to the reception apparatus 120.

As evident from the above explanation, in the transmission method shown in FIG. 4, the processes in the steps S12 and S13, the process in the step S14, and the process in the step S15 are performed in parallel. Therefore, the transmission method shown in FIG. 4 minimizes the delay from the input of the message M to the transmission of the ciphertext C, etc., to the reception apparatus 120. In addition, compared to the method that applies an error correction code to the entire communication content, commonly used in a conventional communication system, the computational complexity and communication volume are reduced since error correction code processing is not performed on the message authentication tag T.

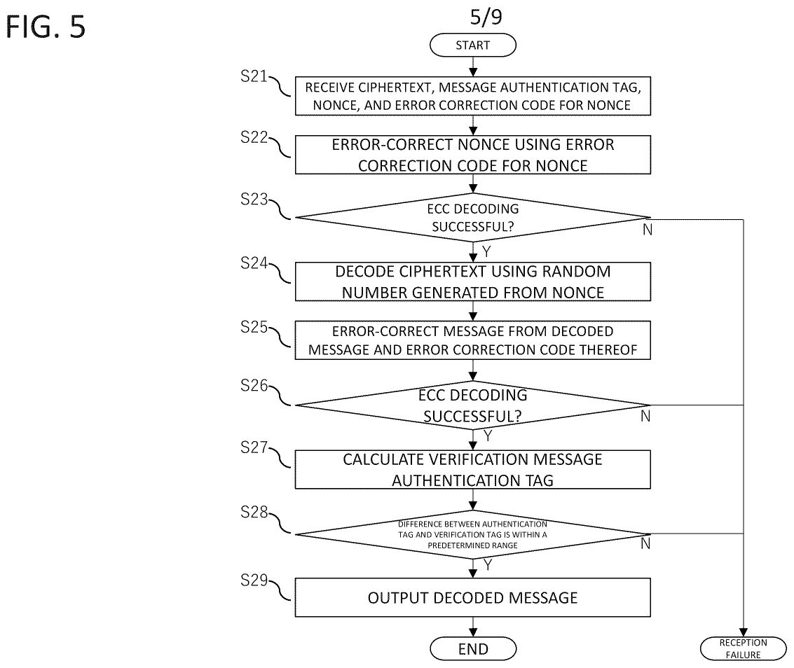

FIG. 5 is a flowchart schematically showing the procedure of the reception method relating to the first example embodiment. The reception method relating to the first example embodiment is a method for decoding a message, using the common key K and the pseudorandom function F shared with the transmission apparatus 110, from the ciphertext C′, the message authentication tag T′, the nonce N′, and the error correction code R(N)′ received from the transmission apparatus 110. As before, it is assumed that the ciphertext C′, the message authentication tag T′, the nonce N′, and the error correction code R(N)′ received contain noise or have been tampered with; therefore, by adding the apostrophes, they are distinguished from the ciphertext C, the message authentication tag T, the nonce N, and the error correction code R(N) transmitted by the transmission apparatus 110.

As shown in FIG. 5, in step S21, the ciphertext C′, the message authentication tag T′, the nonce N′, and the error correction code R(N)′ for the nonce N are received. Then, step S22 performs error correction on the nonce N′ using the error correction code R(N)′ for nonce N. If the error correction is successful (Y in step S23), the nonce N transmitted by the transmission apparatus 110 is decoded. On the other hand, if the error correction fails (N in the step S23), the process terminates as it indicates a failure to correctly receive the communication content.

Next, step S24 decodes the ciphertext C′ received using the error-corrected nonce N. The ciphertext C′ is additively decoded using a random number obtained by supplying the nonce N to the pseudorandom function F. Since the transmission apparatus 110 and the reception apparatus 120 share the pseudorandom function F, it generates the same random number for the same nonce N, and the ciphertext C′ is additively decoded using this random number. The result of decoding the ciphertext C′ is the concatenation M∥R(M)′ of the message M′ and the first error correction code R(M)′.

Then, step S25 decodes the message M by performing error correction on M∥R(M)′. As already explained, the received ciphertext C′ can be considered to be the transmitted ciphertext C with the added error vector e: C′=C+e. The result of additively decoding this is M∥R(M)+e. Since the first error correction code R(M) is encoded with a linear code, one can obtain the message M if the error vector e can be error-corrected. If the error correction is successful (Y in step S26), the message M transmitted by the transmission apparatus 110 can be decoded. On the other hand, if the error correction fails (N in the step S26), the process terminates as it indicates a failure to correctly receive the communication content.

Next, step S27 uses the common key K to calculate the verification message authentication tag T″ from the decoded message M and nonce N. If the message M (and the nonce N) has not been tampered with, this verification message authentication tag T″ should match the message authentication tag T generated by the transmission apparatus 110.

Step S28 compares the verification message authentication tag T″ and the received message authentication tag T′ to see if the difference therebetween is within a predetermined range. If the difference between the verification message authentication tag T″ and the received message authentication tag T′ is within a predetermined range (Y in the step S28), step S29 outputs the decoded message M. On the other hand, if the difference between the verification message authentication tag T″ and the received message authentication tag T′ is outside the predetermined range (N in the step S28), the process terminates as it indicates a failure to correctly receive the communication content.

As already explained, the received message authentication tag T′ does not necessarily match the message authentication tag T generated by the transmission apparatus 110, and the verification message authentication tag T″ may not match the received message authentication tag T′ even if the message M has not been tampered with. Therefore, if the difference between the verification message authentication tag T″ and the received message authentication tag T′ is within the predetermined range, the step S28 determines that the message M has not been tampered with.

As described above, the communication content transmitted by the transmission apparatus 110 is different from what is generally used in the conventional authenticated encryption with error correction functionality, however, the reception method shown in FIG. 5 is capable of decoding the message M while performing error correction and message authentication.

### (Hardware Configuration)

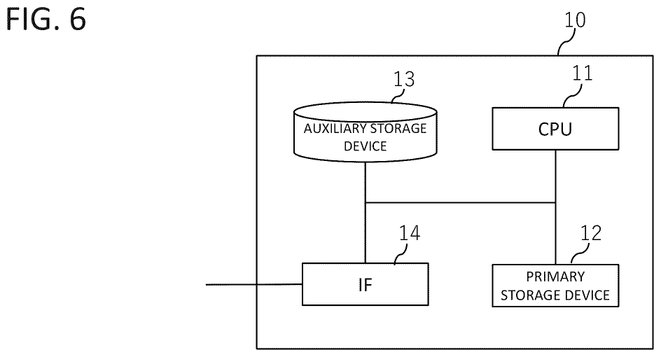

FIG. 6 is a drawing showing an example of the hardware configuration of the apparatuses used in the example embodiment. In other words, the transmission apparatus 110 and the reception apparatus 120 are able to achieve the functions thereof by causing an information processing apparatus employing the hardware configuration shown in FIG. 6 to execute the transmission method or the reception method described above as a program. It should be noted that the hardware configuration example shown in FIG. 6 is merely an example of the hardware configuration that achieves the functions of the transmission apparatus 110 and the reception apparatus 120 and is not intended to limit the hardware configuration of the transmission apparatus 110 and the reception apparatus 120. The transmission apparatus 110 and the reception apparatus 120 may include hardware not shown in FIG. 6.

As shown in FIG. 6, the hardware configuration 10 that may be employed by the transmission apparatus 110 and the reception apparatus 120 comprises a CPU (Central Processing Unit) 11, a primary storage device 12, an auxiliary storage device 13, and an IF (interface) part 14, which are connected to each other by, for instance, an internal bus.

The CPU 11 executes each instruction included in the program executed by the transmission apparatus 110 and the reception apparatus 120. The primary storage device 12 is, for instance, a RAM (Random Access Memory) and temporarily stores various programs such as the program executed by the transmission apparatus 110 and the reception apparatus 120 so that the CPU 11 can process the programs.

The auxiliary storage device 13 is, for instance, an HDD (Hard Disk Drive) and is capable of storing the various programs, such as the program executed by the transmission apparatus 110 and the reception apparatus 120, in the medium to long term. The various programs such as the program may be provided as a program product stored in a non-transitory computer-readable storage medium.

The IF part 14 provides an interface related to, for instance, communication between the transmission apparatus 110 and the reception apparatus 120.

The information processing apparatus employing the hardware configuration 10 described above achieves the functions of the transmission apparatus 110 and the reception apparatus 120 by executing the transmission method or the reception method explained above as a program.

### Second Example Embodiment

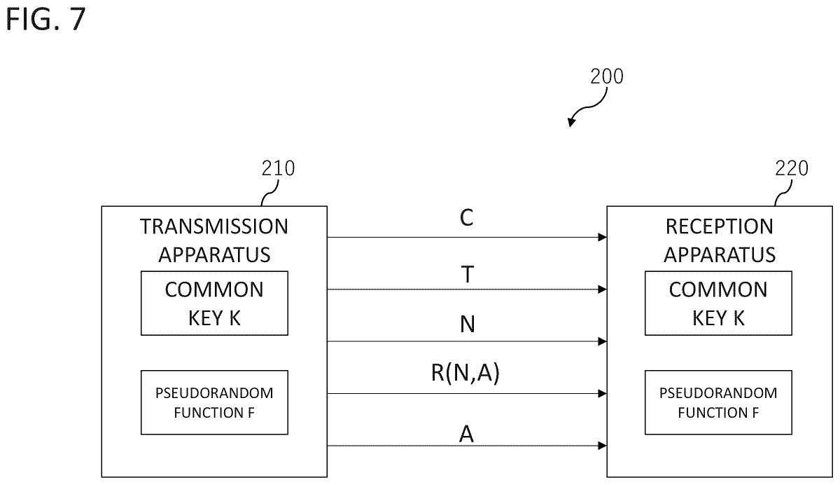

Next, a communication system relating to a second example embodiment will be described. As shown in FIG. 7, the communication system 200 is a system for transmitting a message from a transmission apparatus 210 to a reception apparatus 220 using authenticated encryption with error correction functionality. As shown in FIG. 7, the transmission apparatus 210 transmits the ciphertext C, the message authentication tag T, the nonce N, an error correction code R(N, A), and associated data to the reception apparatus 220. In other words, as compared with the communication system 100 according to the first example embodiment, the associated data is added to the communication content transmitted from the transmission apparatus 210 to the reception apparatus 220 in the communication system 200 relating to the second example embodiment. Here, the associated data is transmitted in plaintext without being encrypted, and it is subject to authentication to ensure that there has been no tampering. For instance, examples of the associated data include a destination address, a protocol header, and the like. Further, in the communication system 200 relating to the second example embodiment, the transmission apparatus 210 and the reception apparatus 220 share the common key K and the pseudorandom function F, as in the communication system 100 relating to the first example embodiment.

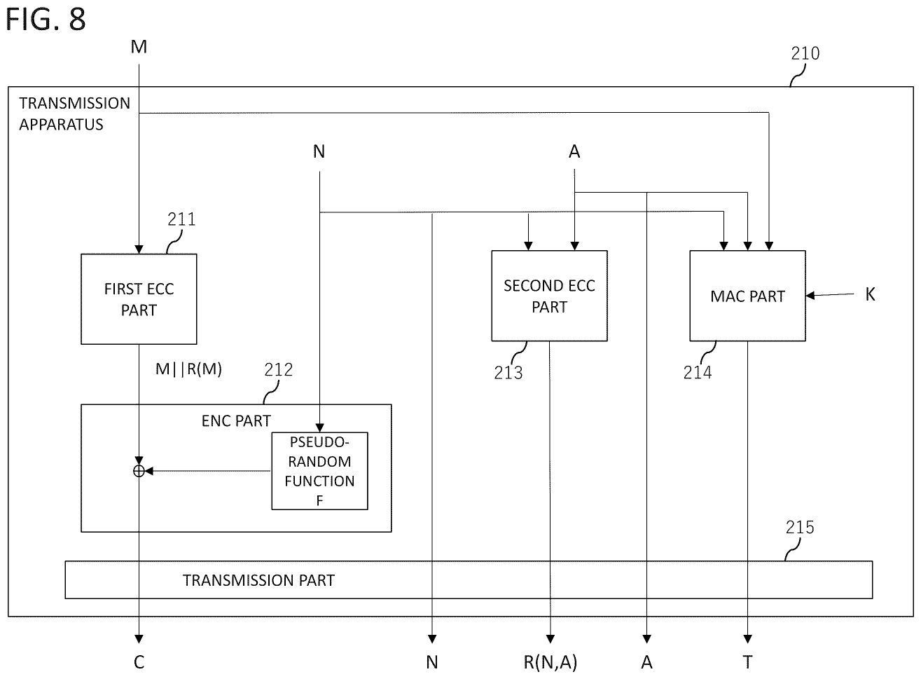

FIG. 8 is a function block diagram of the transmission apparatus relating to the second example embodiment. As shown in FIG. 8, the transmission apparatus 210 comprises a first ECC part 211, an ENC part 212, a second ECC part 213, a MAC part 214, and a transmission part 215.

The first ECC part 211 calculates the first error correction code R(M) from the message M and outputs the concatenation M∥R(M) of the message M and the first error correction code R(M). The ENC part 212 encrypts M∥R(M) outputted from the first ECC part 211 into the ciphertext C. This process is the same as in the first example embodiment.

Meanwhile, the second ECC part 213 calculates the second error correction code R(N, A) from the nonce N and the associated data A. Further, using the common key K, the MAC part 214 calculates the message authentication tag T from an input of the message M, the nonce N, and the associated data A.

Then, the transmission part 215 transmits the ciphertext C, the message authentication tag T, the nonce N, and the second error correction code R(N, A), calculated as described above, along with the associated data A to the reception apparatus 220. Note that, in the transmission apparatus 210, the processing in the first ECC part 211 and the ENC part 212, the processing in the second ECC part 213, and the processing in the MAC part 214 are also performed in parallel as in the first example embodiment.

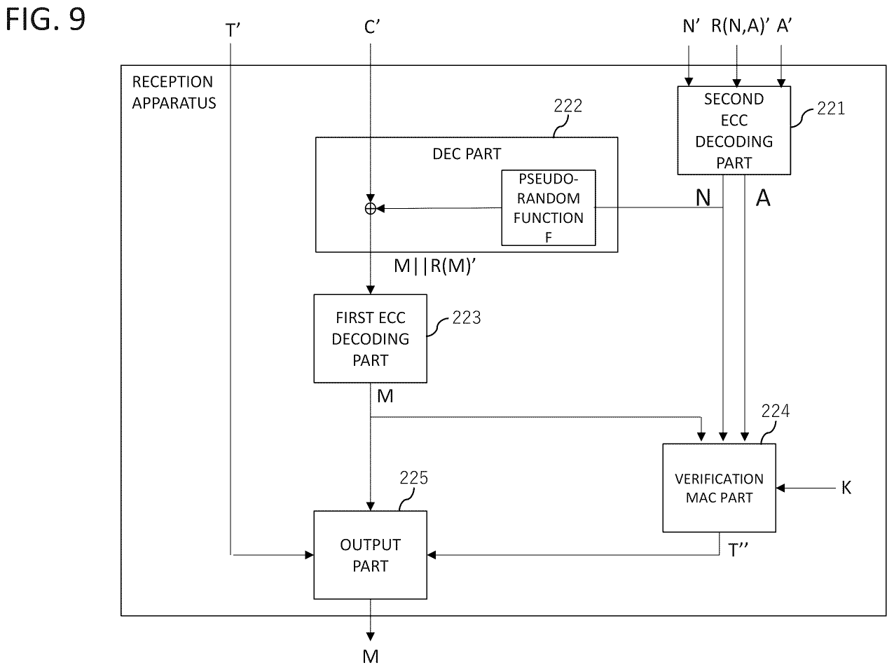

FIG. 9 is a function block diagram of the reception apparatus relating to the second example embodiment. The reception apparatus 220 decodes the message M from the ciphertext C′, the message authentication tag T′, the nonce N′, a second error correction code R(N, A)′, and associated data A′ received from the transmission apparatus 210. Note that it is also assumed here that the ciphertext C′, the message authentication tag T′, the nonce N′, the second error correction code R(N, A)′, and the associated data A′ received from the transmission apparatus 210 contain noise or have been tampered with; therefore, by adding the apostrophes, they are distinguished from the ciphertext C, the message authentication tag T, the nonce N, the second error correction code R(N, A), and the associated data A transmitted by the transmission apparatus 210.

As shown in FIG. 9, the reception apparatus 220 comprises a second ECC decoding part 221, a DEC part 222, a first ECC decoding part 223, a verification MAC part 224, and an output part 225.

The second ECC decoding part 221 performs error correction on the nonce N′ and the associated data A′ using the second error correction code R(N, A)′. If the error correction is successful, the second ECC decoding part 221 outputs the nonce N and the associated data A transmitted by the transmission apparatus 210. On the other hand, if the error correction fails, the process terminates as it indicates a failure to correctly receive the communication content.

The DEC part 222 decodes the ciphertext C′ received from the transmission apparatus 210 using the nonce N error-corrected by the second ECC decoding part 221. Then, the first ECC decoding part 223 decodes the message M by performing error correction on M∥R(M)′. If the error correction fails, the process terminates as it indicates a failure to correctly receive the communication content.

The verification MAC part 224 uses the common key K to calculate a verification message authentication tag T″ from the message M decoded by the first ECC decoding part 223 and the nonce N and the associated data A decoded by the second ECC decoding part 221. Then, the output part 225 compares the verification message authentication tag T″ with the message authentication tag T′ received from the transmission apparatus 210, and if the difference therebetween is within a predetermined range, the output part 225 outputs the message M obtained by the first ECC decoding part 223.

As described above, even if the communication content transmitted by the transmission apparatus 210 includes associated data such as a destination address and a protocol header, the reception apparatus 220 is able to decode the message M while performing error correction and message authentication. In other words, the communication system according to the second example embodiment can be applied to more practical communication methods.

### (Effect of Reducing Communication Volume)

Next, the effect of reducing the communication volume in the communication system 200 relating to the second example embodiment will be illustrated. For instance, let's assume that the message M, the nonce N, the message authentication tag T, and the associated data A are all 64 bits in size and error correction code processing is performed on each of these elements using SEC-DED (72, 64). Here, SEC-DED is an abbreviation for Single Error Correction, Double Error Detection, which is error correction code processing that allows error correction of 1 bit and detection of up to 2-bit errors at the same time. Note that (72, 64) means adding 8 bits to 64-bit data to convert it into a 72-bit code.

In this example, if error correction processing is conventionally performed on the entire communication content after authenticated encryption processing has been performed, an overhead of 32 bits occurs. Meanwhile, in the communication system relating to the second example embodiment, an 8-bit overhead occurs for the message M in the first ECC part 211, and an 8-bit overhead occurs for each of the nonce N and the associated data A (totaling 16 bits) in the second ECC part 213. Therefore, the total overhead generated in the first ECC part 211 and the second ECC part 213 is 24 bits. In other words, in the communication system 200 relating to the second example embodiment, the overhead can be reduced by 25 percent, compared to the conventional method.

Some or all of the example embodiments above can be described as (but not limited to) the following Supplementary Notes.

### [Supplementary Note 1]

A communication system transmitting a message from a transmission apparatus to a reception apparatus using a common key and a pseudorandom function shared by the transmission apparatus and the reception apparatus, and a nonce generated by
the transmission apparatus, wherein
the transmission apparatus comprises:
a first ECC part that calculates a first error correction code from the message;
an ENC part that additively encrypts a concatenation of the message and the first error correction code using a random number obtained by supplying the nonce to the pseudorandom function to output a ciphertext;
a MAC part that calculates a message authentication tag for the message and the nonce using the common key;
a second ECC part that calculates a second error correction code from the nonce; and
a transmission part that transmits the ciphertext, the message authentication tag, the nonce, and the second error correction code to the reception apparatus, and
the reception apparatus comprises:
a second ECC decoding part that performs error correction on the nonce using the second error correction code;
a DEC part that decodes the message and the first error correction code from the ciphertext using a random number obtained by supplying the nonce to the pseudorandom function;
a first ECC decoding part that performs error correction on the message using the first error correction code;
a verification MAC part that calculates a verification message authentication tag using the common key from the message outputted by the first ECC decoding part and the nonce outputted by the second ECC decoding part; and
an output part that compares the verification message authentication tag with the message authentication tag and outputs the message if the difference therebetween is within a predetermined range.

### [Supplementary Note 2]

The communication system according to Supplementary Note 1, wherein
the transmission part further transmits associated data that is transmitted in plaintext and subject to detect tampering,
the second ECC part calculates the second error correction code by concatenating the associated data with the nonce,
the MAC part calculates a message authentication tag by further including the associated data,
the second ECC decoding part performs error correction on the associated data using the second error correction code, and
the verification MAC part calculates the verification message authentication tag by including the associated data outputted by the second ECC decoding part as an input.

### [Supplementary Note 3]

The communication system according to Supplementary Note 1 or 2, wherein the verification message authentication tag and the message authentication tag are compared to see if the Hamming distance between the verification message authentication tag and the message authentication tag is within a predetermined range.

### [Supplementary Note 4]

The communication system according to any one of Supplementary Notes 1 to 3, wherein the first error correction code is a linear code.

### [Supplementary Note 5]

A transmission apparatus transmitting a message to a reception apparatus using a common key and a pseudorandom function shared with the reception apparatus, and a nonce generated, the transmission apparatus comprising:
a first ECC part that calculates a first error correction code from the message;
an ENC part that additively encrypts a concatenation of the message and the first error correction code using a random number obtained by supplying the nonce to the pseudorandom function to output a ciphertext;
a MAC part that calculates a message authentication tag for the message and the nonce using the common key;
a second ECC part that calculates a second error correction code from the nonce; and
a transmission part that transmits the ciphertext, the message authentication tag, the nonce, and the second error correction code to the reception apparatus.

### [Supplementary Note 6]

A reception apparatus decoding a message from a ciphertext, a message authentication tag, a nonce, and a second error correction code received from a transmission apparatus using a common key and a pseudorandom function shared with the transmission apparatus, the reception apparatus comprising:
a second ECC decoding part that performs error correction on the nonce using the second error correction code;
a decoding part that decodes the message and a first error correction code from the ciphertext using a random number obtained by supplying the nonce to the pseudorandom function;
a first ECC decoding part that performs error correction on the message using the first error correction code;
a verification MAC part that calculates a verification message authentication tag using the common key from the message outputted by the first ECC decoding part and the nonce outputted by the second ECC decoding part; and
an output part that compares the verification message authentication tag with the message authentication tag and outputs the message if the difference therebetween is within a predetermined range.

### [Supplementary Note 7]

A communication method transmitting a message from a transmission apparatus to a reception apparatus using a common key and a pseudorandom function shared by the transmission apparatus and the reception apparatus, and a nonce generated by the transmission apparatus, the communication method including:
causing the transmission apparatus to:
calculate a first error correction code from the message;
additively encrypt a concatenation of the message and the first error correction code using a random number obtained by supplying the nonce to the pseudorandom function to output a ciphertext;
calculate a message authentication tag for the message and the nonce using the common key;
calculate a second error correction code from the nonce; and
transmit the ciphertext, the message authentication tag, the nonce, and the second error correction code to the reception apparatus; and
causing the reception apparatus to:
perform error correction on the nonce using the second error correction code;
decode the message and the first error correction code from the ciphertext using a random number obtained by supplying the nonce to the pseudorandom function;
perform error correction on the message using the first error correction code;
calculate a verification message authentication tag using the common key from the error-corrected message and the error-corrected nonce; and
compare the verification message authentication tag with the message authentication tag and output the message if the difference therebetween is within a predetermined range.

### [Supplementary Note 8]

A transmission method transmitting a message to a reception apparatus using a common key and a pseudorandom function shared with the reception apparatus, and a nonce generated, the transmission method including:
calculating a first error correction code from the message; additively encrypting a concatenation of the message and the first error correction code using a random number obtained by supplying the nonce to the pseudorandom function to output a ciphertext;
calculating a message authentication tag for the message and the nonce using the common key;
calculating a second error correction code from the nonce; and
transmitting the ciphertext, the message authentication tag, the nonce, and the second error correction code to the reception apparatus.

### [Supplementary Note 9]

A reception method decoding a message from a ciphertext, a message authentication tag, a nonce, and a second error correction code received from a transmission apparatus using a common key and a pseudorandom function shared with the transmission apparatus, the reception method including:
performing error correction on the nonce using the second error correction code;
decoding the message and a first error correction code from the ciphertext using a random number obtained by supplying the nonce to the pseudorandom function;
performing error correction on the message using the first error correction code;
calculating a verification message authentication tag using the common key from the error-corrected message and the error-corrected nonce; and
comparing the verification message authentication tag with the message authentication tag and outputting the message if the difference therebetween is within a predetermined range.

### [Supplementary Note 10]

A communication program causing a transmission apparatus and a reception apparatus to perform a process of transmitting a message from the transmission apparatus to the reception apparatus using a common key and a pseudorandom function shared by the transmission apparatus and the reception apparatus, and a nonce generated by the transmission apparatus, wherein
the communication program causes the transmission apparatus to perform processes of:
calculating a first error correction code from the message;
additively encrypting a concatenation of the message and the first error correction code using a random number obtained by supplying the nonce to the pseudorandom function to output a ciphertext;
calculating a message authentication tag for the message and the nonce using the common key;
calculating a second error correction code from the nonce; and
transmitting the ciphertext, the message authentication tag, the nonce, and the second error correction code to the reception apparatus, and
the communication program causes the reception apparatus to perform processes of:
performing error correction on the nonce using the second error correction code;
decoding the message and the first error correction code from the ciphertext using a random number obtained by supplying the nonce to the pseudorandom function;
performing error correction on the message using the first error correction code;
calculating a verification message authentication tag using the common key from the error-corrected message and the error-corrected nonce; and
comparing the verification message authentication tag with the message authentication tag and outputting the message if the difference therebetween is within a predetermined range.

### [Supplementary Note 11]

A transmission program causing a transmission apparatus to perform a process of transmitting a message to a reception apparatus using a common key and a pseudorandom function shared with the reception apparatus, and a nonce generated, the transmission program causing the transmission apparatus to perform processes of:
calculating a first error correction code from the message;
additively encrypting a concatenation of the message and the first error correction code using a random number obtained by supplying the nonce to the pseudorandom function to output a ciphertext;
calculating a message authentication tag for the message and the nonce using the common key;
calculating a second error correction code from the nonce; and
transmitting the ciphertext, the message authentication tag, the nonce, and the second error correction code to the reception apparatus.

### [Supplementary Note 12]

A reception program causing a reception apparatus to perform a process of decoding a message from a ciphertext, a message authentication tag, a nonce, and a second error correction code received from a transmission apparatus using a common key and a pseudorandom function shared with the transmission apparatus, the reception program causing the reception apparatus to perform processes of:
performing error correction on the nonce using the second error correction code;
decoding the message and a first error correction code from the ciphertext using a random number obtained by supplying the nonce to the pseudorandom function;
performing error correction on the message using the first error correction code;
calculating a verification message authentication tag using the common key from the error-corrected message and the error-corrected nonce; and
comparing the verification message authentication tag with the message authentication tag and outputting the message if the difference therebetween is within a predetermined range.

Further, the disclosure of Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, using some or all of the disclosed matters in the literatures cited above as necessary, in combination with the matters described herein, as part of the disclosure of the present invention in accordance with the object thereof shall be considered to be included in the disclosed matters of the present application.

### REFERENCE SIGNS LIST

10: hardware configuration
11: CPU
12: primary storage device
13: auxiliary storage device
14: IF part
100, 200: communication system
110, 210: transmission apparatus
111, 211: first ECC part
112, 212: ENC part
113, 213: second ECC part
114, 214: MAC part
115, 215: transmission part
120, 220: reception apparatus
121, 221: second ECC decoding part
122, 222: DEC part
123, 223: first ECC decoding part
124, 224: verification MAC part
125, 225: output part

What is claimed is:

1. A communication system transmitting a message from a transmission apparatus to a reception apparatus using a common key and a pseudorandom function shared by the transmission apparatus and the reception apparatus, and a nonce generated by the transmission apparatus, wherein
the transmission apparatus comprises:
a first ECC part that calculates a first error correction code from the message;
an ENC part that additively encrypts a concatenation of the message and the first error correction code using a random number obtained by supplying the nonce to the pseudorandom function to output a ciphertext;
a MAC part that calculates a message authentication tag for the message and the nonce using the common key;
a second ECC part that calculates a second error correction code from the nonce; and
a transmission part that transmits the ciphertext, the message authentication tag, the nonce, and the second error correction code to the reception apparatus, and
the reception apparatus comprises:
a second ECC decoding part that performs error correction on the nonce using the second error correction code;
a DEC part that decodes the message and the first error correction code from the ciphertext using a random number obtained by supplying the nonce to the pseudorandom function;
a first ECC decoding part that performs error correction on the message using the first error correction code;
a verification MAC part that calculates a verification message authentication tag using the common key from the message outputted by the first ECC decoding part and the nonce outputted by the second ECC decoding part; and
an output part that compares the verification message authentication tag with the message authentication tag and outputs the message if the difference therebetween is within a predetermined range.

2. The communication system according to claim 1, wherein
the transmission part further transmits associated data that is transmitted in plaintext and subject to detect tampering,
the second ECC part calculates the second error correction code by concatenating the associated data with the nonce,
the MAC part calculates a message authentication tag by further including the associated data,
the second ECC decoding part performs error correction on the associated data using the second error correction code, and
the verification MAC part calculates the verification message authentication tag by including the associated data outputted by the second ECC decoding part as an input.

3. The communication system according to claim 1, wherein the verification message authentication tag and the message authentication tag are compared to see if the Hamming distance between the verification message authentication tag and the message authentication tag is within a predetermined range.

4. The communication system according to claim 1, wherein the first error correction code is a linear code.

5. A transmission apparatus transmitting a message to a reception apparatus using a common key and a pseudorandom function shared with the reception apparatus, and a nonce generated, the transmission apparatus comprising:
a first ECC part that calculates a first error correction code from the message;
an ENC part that additively encrypts a concatenation of the message and the first error correction code using a random number obtained by supplying the nonce to the pseudorandom function to output a ciphertext;
a MAC part that calculates a message authentication tag for the message and the nonce using the common key;
a second ECC part that calculates a second error correction code from the nonce; and
a transmission part that transmits the ciphertext, the message authentication tag, the nonce, and the second error correction code to the reception apparatus.

6. A reception apparatus decoding a message from a ciphertext, a message authentication tag, a nonce, and a second error correction code received from a transmission apparatus using a common key and a pseudorandom function shared with the transmission apparatus, the reception apparatus comprising:
a second ECC decoding part that performs error correction on the nonce using the second error correction code;
a decoding part that decodes the message and a first error correction code from the ciphertext using a random number obtained by supplying the nonce to the pseudorandom function;
a first ECC decoding part that performs error correction on the message using the first error correction code;
a verification MAC part that calculates a verification message authentication tag using the common key from the message outputted by the first ECC decoding part and the nonce outputted by the second ECC decoding part; and
an output part that compares the verification message authentication tag with the message authentication tag and outputs the message if the difference therebetween is within a predetermined range.

7. A communication method transmitting a message from a transmission apparatus to a reception apparatus using a common key and a pseudorandom function shared by the transmission apparatus and the reception apparatus, and a nonce generated by the transmission apparatus, the communication method comprising:
causing the transmission apparatus to:
calculate a first error correction code from the message;
additively encrypt a concatenation of the message and the first error correction code using a random number obtained by supplying the nonce to the pseudorandom function to output a ciphertext;
calculate a message authentication tag for the message and the nonce using the common key;
calculate a second error correction code from the nonce; and
transmit the ciphertext, the message authentication tag, the nonce, and the second error correction code to the reception apparatus; and
causing the reception apparatus to:
perform error correction on the nonce using the second error correction code;
decode the message and the first error correction code from the ciphertext using a random number obtained by supplying the nonce to the pseudorandom function;
perform error correction on the message using the first error correction code;
calculate a verification message authentication tag using the common key from the error-corrected message and the error-corrected nonce; and
compare the verification message authentication tag with the message authentication tag and output the message if the difference therebetween is within a predetermined range.

8. A transmission method transmitting a message to a reception apparatus using a common key and a pseudorandom function shared with the reception apparatus, and a nonce generated, the transmission method comprising:
calculating a first error correction code from the message;
additively encrypting a concatenation of the message and the first error correction code using a random number obtained by supplying the nonce to the pseudorandom function to output a ciphertext;
calculating a message authentication tag for the message and the nonce using the common key;
calculating a second error correction code from the nonce; and
transmitting the ciphertext, the message authentication tag, the nonce, and the second error correction code to the reception apparatus.

9. A reception method decoding a message from a ciphertext, a message authentication tag, a nonce, and a second error correction code received from a transmission apparatus using a common key and a pseudorandom function shared with the transmission apparatus, the reception method comprising:
performing error correction on the nonce using the second error correction code;
decoding the message and a first error correction code from the ciphertext using a random number obtained by supplying the nonce to the pseudorandom function;
performing error correction on the message using the first error correction code;
calculating a verification message authentication tag using the common key from the error-corrected message and the error-corrected nonce; and
comparing the verification message authentication tag with the message authentication tag and outputting the message if the difference therebetween is within a predetermined range.

10.-12. (canceled)

13. The transmission apparatus according to claim 5, wherein
the transmission part further transmits associated data that is transmitted in plaintext and subject to detect tampering,
the second ECC part calculates the second error correction code by concatenating the associated data with the nonce, and
the MAC part calculates a message authentication tag by further including the associated data.

14. The transmission apparatus according to claim 5, wherein the first error correction code is a linear code.

15. The reception apparatus according to claim 6, wherein
the reception apparatus further receives associated data from transmission apparatus,
the second ECC decoding part performs error correction on the associated data using the second error correction code, and
the verification MAC part calculates the verification message authentication tag by including the associated data outputted by the second ECC decoding part as an input.

16. The reception apparatus according to claim 6, wherein the verification message authentication tag and the message authentication tag are compared to see if the Hamming distance between the verification message authentication tag and the message authentication tag is within a predetermined range.

17. The reception apparatus according to claim 6, wherein the first error correction code is a linear code.

18. The communication method according to claim 7, including:
causing the transmission apparatus to:
transmit associated data that is transmitted in plaintext and subject to detect tampering;
calculate the second error correction code by concatenating the associated data with the nonce; and
calculate a message authentication tag by further including the associated data, and
causing the reception apparatus to:
perform error correction on the associated data using the second error correction code; and
calculate the verification message authentication tag by including the associated data outputted by the second ECC decoding part as an input.

19. The communication method according to claim 7, wherein the verification message authentication tag and the message authentication tag are compared to see if the Hamming distance between the verification message authentication tag and the message authentication tag is within a predetermined range.

20. The transmission method according to claim 8, including:
further transmitting associated data that is transmitted in plaintext and subject to detect tampering;
calculating the second error correction code by concatenating the associated data with the nonce; and
calculating a message authentication tag by further including the associated data.

21. The transmission method according to claim 8, wherein the first error correction code is a linear code.

22. The reception method according to claim 9, including:
receiving associated data from transmission apparatus;
performing error correction on the associated data using the second error correction code; and
calculating the verification message authentication tag by including the associated data outputted by the second ECC decoding part as an input.

23. The reception method according to claim 9, wherein the verification message authentication tag and the message authentication tag are compared to see if the Hamming distance between the verification message authentication tag and the message authentication tag is within a predetermined range.
